(19) United States
(12) Patent Application Publication
(10) Pub. No.: US 2004/0135354 A1
(43) Pub. Date: Jul. 15, 2004

(54) Occupant protection apparatus for vehicle

(76) Inventors: Tsunenori Kishimoto, Okazaki-shi (JP); Kazuyuki Kuriyama, Okazaki-shi (JP); Shigeyuki Nozumi, Anjo-shi (JP); Takami Sugiyama, Okazaki-shi (JP); Yohei Mabashi, Okazaki-shi (JP)

Correspondence Address: BIRCH STEWART KOLASCH & BIRCH, PO BOX 747, FALLS CHURCH, VA, 22040-0747, US

(21) Appl. No.: 10/695,898

(22) Filed: Oct. 30, 2003

(30) Foreign Application Priority Data
Oct. 31, 2002 (JP) 2002-317876

(51) Int. Cl. B60R 21/32; B60K 28/02

(52) U.S. Cl. 280/735; 180/272

(57) ABSTRACT

There is provided an occupant protection apparatus which is comprised of a weight sensor which detects the physical quantity such as the weight relating to the physique of an occupant seated on a passenger seat; an ECU which determines the physique of the occupant according to the detected weight, and renders an air bag device for the passenger seat inoperative when determining that the occupant is a child having a physique equal to or smaller than a predetermined physique; and an air bag OFF lamp which is turned on to notify that the air bag device for the passenger seat is inoperative so as to prompt another occupant to take any occupant-protective measure other than the use of the air bag device.

### CROSS-REFERENCE TO RELATED APPLICATION

This application incorporates by references the subject matter of Application NO. 2002-317876 filed in Japan on 31 Oct. 2003, on which a priority claim is based under 35 U.S.C §119(a).

### BACKGROUND OF THE INVENITON

1. Field of the Invention

The present invention relates to an occupant protection apparatus for a vehicle, which ensures safety for an occupant seated on a passenger seat.

2. Description of the Related Art

An automobile (vehicle) is equipped with seat belt devices and/or air bag devices for front seats (a driver seat and a passenger seat). These devices are intended to protect a seated occupant from an impact force upon frontal collision; in the event of a collision, the seat belt device is operable to restrain the upper body of the occupant or inhibit the movement of the upper body. An example of such devices is disclosed in Japanese Unexamined Patent Publication (Kohyo) No. 2001-504770.

The air bag device as described above is configured such that an air bag is instantaneously inflated by gas generated from an inflator, and hence at the time of inflation, a large force is likely to be applied to the occupant.

Therefore, for example, if the occupant seated on the passenger is an infant (child) put on a child-car seat, he/she is more likely to be affected by the inflated air bag since he/she weighs less than an adult.

### SUMMARY OF THE INVENTION

It is an object of the present invention to provide an occupant protection apparatus for a vehicle, which is capable of preventing a great force from being applied to an infant (child) seated on a passenger seat when an air bag is inflated, thereby securing the safety for the infant.

To attain the above object, there is provided an occupant protection apparatus that detects a physical quantity relating to the physique of an occupant seated on a passenger seat by a detecting device, renders an air bag device for the passenger seat inoperative, and then notifies that the air bag device for the passenger seat is inoperative by a notifying device.

### BRIEF DESCRIPTION OF THE DRAWINGS

The nature of this invention, as well as other objects and advantages thereof, will be explained in the following with reference to the accompanying drawings, in which like reference character designate the same or similar parts throughout the figures and wherein:

FIG. 1 is a plan view showing an occupant protection apparatus according to an embodiment of the present invention;

FIG. 2 is a side view showing the occupant protection apparatus in FIG. 1;

FIG. 3 is a block diagram showing a control system of the occupant protection apparatus in FIG. 1;

FIG. 4 is a diagram showing a map for controlling an air bag device for a driver seat;

FIG. 5 is a diagram showing a map for controlling an air bag device for a passenger seat; and

FIG. 6 is a diagram showing a map for controlling an air bag OFF lamp.

### DETAILED DESCRIPTION OF THE PREFERED EMBODIMENTS

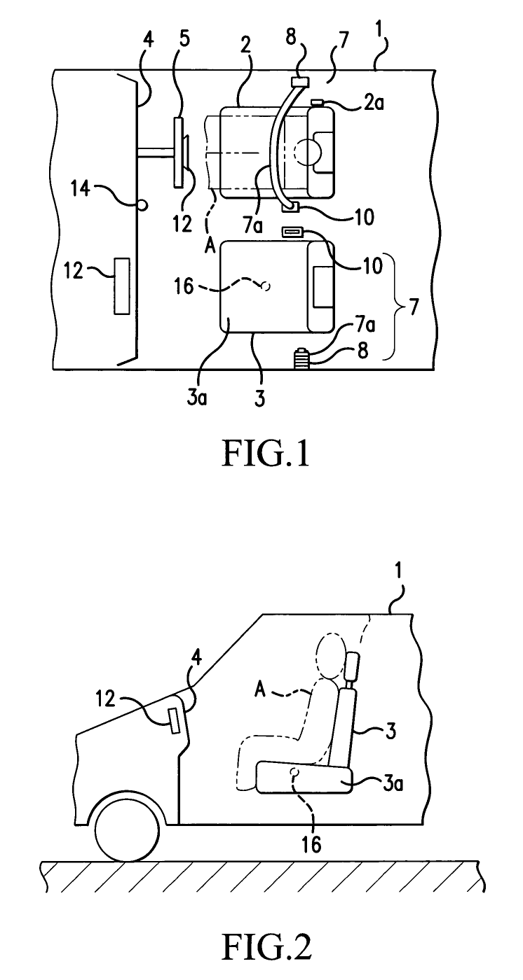

The present invention will now be described in detail with reference to FIGS. 1 to 6 showing a preferred embodiment thereof.

In FIGS. 1 and 2, reference numeral 1 denotes a vehicle body; 2, a driver seat that is located at the front of the vehicle body 1 and is capable of being slide-adjusted in the direction of the length of a vehicle; 3, a passenger seat juxtaposed with the driver seat 2 in the direction of the width of the vehicle; 4, an instrument panel mounted at the front of the driver seat 2 and the passenger seat 3; and 5, a steering wheel adapted to project from the instrument panel 4 toward the driver seat 2. It should be noted that the front and rear slide positions of the driver seat 2 are detected using a seated position recognition device (slide sensor 2a) which recognizes the position of an occupant seated on the driver seat 2.

A seat belt device 7 which restrains the upper body of an occupant A seated on each of the seats 2 and 3 is provided In the vicinity of each of the driver seat 2 and the passenger seat 3. The seat belt device 7 is comprised of e.g. a pre-tensioner that is a combination of a retractor 8 which retractably stores a seat belt 7a (illustrated only in FIG. 1), and a buckle 10 which can be attached and detached to and from a tongue, not shown, at an end of the seat belt 7a.

Further, air bag devices 12 are respectively provided at the center of the steering wheel 5 and at a part of the instrument panel 4 in front of the passenger seat 3. The air bag devices 12 are each configured such that a folded air bag thereof is inflated in a direction toward the driver seat 2 or the passenger seat 3 by gas generated from an inflator, for example. It should be noted that each of the air bag devices 12 employs a controller which controls the inflating power of the air bag device 12 by e.g. selecting a one-stage operation mode in which the air bag is inflated at a lower gas pressure or by a smaller amount of gas than normal, and a two-stage operation mode in which the air bag is inflated at a normal gas pressure.

In a vehicle compartment, e.g. on a surface of the instrument panel 14, an air bag OFF lamp (notifying device) 14, for example, is provided as a notifying device which notifies that the air bag device 12 for the passenger seat 3 is not capable of operating, i.e. is inoperative.

Further, a seat cushion 3a constituting the passenger seat 3 is equipped with e.g. a weight sensor (detecting device) 16 which detects the physical quantity relating to the physique of the occupant seated on the passenger seat 3. According to the occupant's weight detected by the weight sensor 16, a determination device implemented by an ECU (Electronic Control Unit) (determination device; air bag inoperative device) 17, described later, determines whether or not the physique of the occupant seated on the passenger seat 3 is equal to or smaller than a predetermined physique, whereby it is determined whether the seated occupant is an adult or a child, or the passenger seat is unoccupied. It goes without saying that if the seated occupant is an adult who is as small in physique as a child, it is determined that his/her physique is equal to or smaller than the predetermined physique.

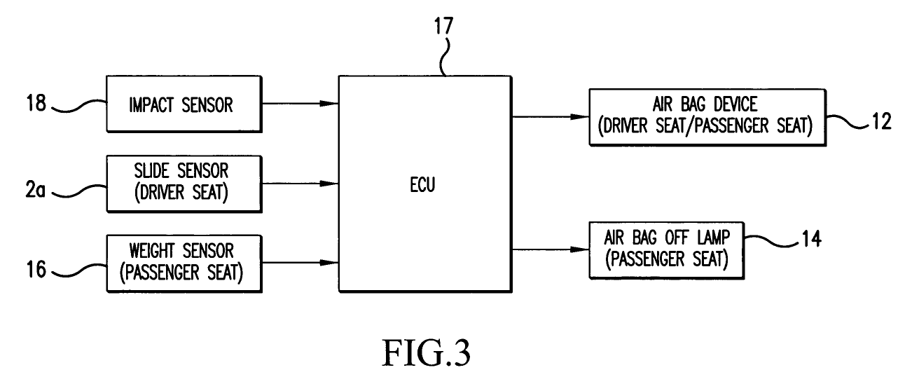

The ECU 17 in FIG. 3 is comprised of a microcomputer, for example. An impact sensor 18, which is disposed at the front of the vehicle body 1, is connected to the ECU 17. The slide sensor 2a, air bag devices 12, air bag OFF lamp 14, and weight sensor 16 are also connected to the ECU 17.

Further, the ECU 17 is configured to execute functions as described below.

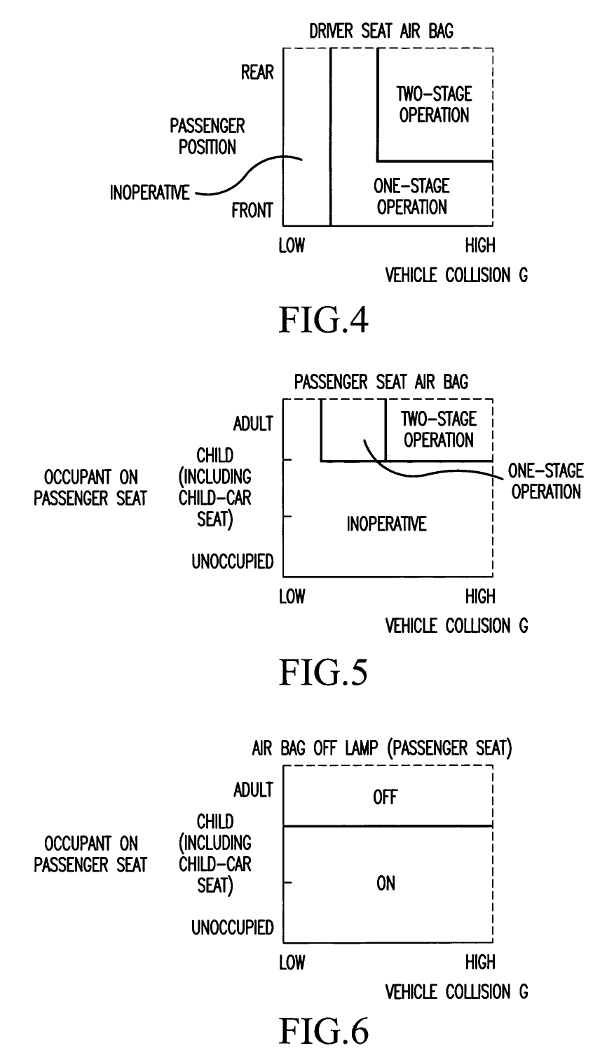

The ECU 17 provides control to set the operation mode of the air bag device 12 according to a signal detected by the slide sensor 2a and a signal detected by the impact sensor 17 in accordance with a map in FIG. 4. The greater the impact detected by the impact sensor 18 and the remoter the occupant seated on the driver seat 2 from the steering wheel 5, the higher is the gas pressure at which the air bag is inflated. In further detail, for example, when a vehicle collision G (the impact detected by the impact sensor 18) is low, the air bag is rendered inoperative irrespective of the occupant's position detected by the slide sensor 2a. When the vehicle collision G is high, the air bag is inflated in the one-stage operation mode at a lower gas pressure or by a smaller amount of gas than normal irrespective of the occupant's position. When the vehicle collision G is much higher, the air bag is inflated in the one-stage operation mode for the reason that in the case where the occupant is close to the steering wheel 5, a large force is likely to be applied to the occupant if the air bag is inflated in the two-stage operation mode at a normal gas pressure or by a normal amount of gas. When the occupant is remote from the steering wheel 5, the air bag is inflated in the two-stage operation mode.

The operation of the air bag device 12 for the passenger seat 3 is controlled according to the result of the determination made by the determination device in response to a signal indicative of the weight (physical quantity relating to the physique) detected by the weight sensor 16 and a signal detected by the impact sensor 18 in accordance with a map in FIG. 5. That is, when the determination device determines that the occupant is an adult, the air bag is caused to be inflated upon detection of impact by the impact sensor 18 in the same manner as is the case with the air bag device 12 for the driver seat 2. When the determination device determines that the occupant is a child who weighs e.g. 20 kg (a predetermined weight) or less (an infant; including a child-car seat), the air bag device 12 for the passenger seat 3 is not caused to be inflated, irrespective of the signal detected by the impact sensor 18. Namely, the ECU 17 functions as an air bag inoperative device to render the air bag device 12 for the passenger seat 3 inoperative. It should be noted that when no occupant is seated on the passenger seat 3, i.e. when the passenger seat 3 is unoccupied, the ECU 17 is operable to render the air bag device 12 for the passenger seat 3 inoperative.

As for the operation of the air bag OFF lamp 14, when the determination device determines that the occupant seated on the passenger seat 3 is an adult according to a signal indicative of the weight (physical quantity relating to the physique) detected by the weight sensor 16, the air bag OFF lamp 14 is turned off. On the other hand, when the determination device determines that the occupant seated on the passenger seat 3 is a child (including a child-car seat) who weighs e.g. 20 kg (a predetermined weight) or less, and when the determination device determines that the passenger seat 3 is unoccupied, the air bag OFF lamp 14 is turned on to notify that the air bag device 12 for the passenger seat 3 is inoperative.

A description will now be given of the operation of the occupant protection apparatus constructed as described above. It is assumed here that an infant (including an infant put on a child-car seat) is seated on the passenger seat 3.

Then, according to a signal output from the weight sensor 16 mounted on the passenger seat 3, the ECU 17 determines that the occupant seated on the passenger seat 3 is an infant (child) with a threshold being set to 20 kg, for example,

Here, even in the one-stage operation mode in which the airbag is inflated at a low pressure of gas or by a small amount of gas, an infant (child) who is small in physique and weighs less is more likely to be affected by the inflated air bag than an adult.

For this reason, in accordance with the map in FIG. 5, the ECU 17 provides control to inhibit the air bag device 12 for the passenger seat 3 from operating. Further, in accordance with a map in FIG. 6, the ECU 17 provides control to turn on the air bag OFF lamp 14 provided on the instrument panel 4, for example, so as to notify the driver or another occupant that the air bag device 12 for the passenger seat 3 is inoperative.

In response to a warning given by turning-on of the air bag OFF lamp 14, the driver or another occupant takes any measure other than the air bag device 12 to ensure safety for the infant, so that a large force is prevented from being applied to the infant (child) when the air bag of the air bag device 12 is inflated. Examples of the measure taken for ensuring safety other than the use of the air bag device 12 includes seating of the infant (child) on a rear seat which ensures safety, and additional attachment of a device, which holds the body by utilizing the functions of the seat belt device 7, to the seat belt 7a of the seat belt device 7 so as to ensure safety in a manner being dependent on the seat belt device 7.

Therefore, by just seating an infant (child) on the passenger seat 3, it can be determined whether the infant will be affected by the air bag device 12 or not, and accordingly, the driver or another occupant can determine whether the infant will be affected by the air bag device 12 and then take any measure to prevent the infant from being affected by the air bag device 12. Therefore, it is possible to ensure safety for an infant (child). Furthermore, the physique of an occupant is determined using the weight sensor 16 which is intended to detect the weight of an occupant, and hence even an occupant having a physique equal to or smaller than a predetermined physique, i.e. a child can be easily detected.

It should be understood that the present invention is not limited to the embodiment described above, but various variations of the above described embodiment may be possible without departing from the spirits of the present invention, including variations as described below, for example. Although in the above described embodiment, the turning-on of the air bag OFF lamp notifies that the air bag device is inoperative, the present invention is not limited to this, but for example, either light indication other than turning-on/off of light or a sound may be used to notify that the air bag device is inoperative.

Further, it may be notified that the air bag device is operative.

Further, the determination device, which determines the physique of an occupant, and the weight sensor may be configured as an integral unit so that a signal indicative of an adult, a child, or an unoccupied seat, not a signal indicative of the weight, can be transmitted to the ECU.

What is claimed is:

1. An occupant protection apparatus for a vehicle, including an air bag device that restrains an occupant seated on a passenger seat, comprising:
a detecting device that detects a physical quantity relating to a physique of the occupant seated on the passenger seat;
a determination device that determines the physique of the occupant according to the physical quantity detected by said detecting device;
an air bag inoperative device renders the air bag device inoperative when said determination device determines that the physique of the occupant is equal to or smaller than a predetermined physique; and
a notifying device that notifies that the air bag device is inoperative when the air bag device is rendered inoperative by said air bag inoperative device.

2. An occupant protection apparatus for a vehicle according to claim 1, wherein when said determination device determines that the physique of the occupant becomes greater than the predetermined physique, said notifying device notifies that the air bag device is operative in a manner of notification different from a manner in which it is notified that the air bag device is inoperative.

3. An occupant protection apparatus for a vehicle according to claim 1, wherein said determination device determines whether the occupant is an adult or a child (a person who is small in stature) or the passenger seat is unoccupied according to the physique of the occupant.

4. An occupant protection apparatus for a vehicle according to claim 1, wherein said detecting device comprises a weight sensor mounted on the passenger seat, for detecting a weight of the occupant seated on the passenger seat.

5. An occupant protection apparatus for a vehicle according to claim 4, wherein said determination device determines whether the occupant is an adult or a child (a person who is small in stature) or the passenger seat is unoccupied according to the physique of the occupant.

6. An occupant protection apparatus for a vehicle, including an air bag device that restrains an occupant seated on a passenger seat, comprising:
a detecting device that detects a weight of the occupant seated on the passenger seat;
an air bag inoperative device that renders the air bag device inoperative when the weight of the occupant detected by said detecting device is equal to or smaller than a predetermined value; and
a notifying device that notifies that the air bag device is inoperative when the air bag device is rendered inoperative by said air bag inoperative device.
